(19) United States
(12) Patent Application Publication
(10) Pub. No.: US 2019/0317459 A1
(43) Pub. Date: Oct. 17, 2019

(54) PREDICTIVE REACTOR EFFLUENT AIR COOLER MAINTENANCE

(71) Applicant: HONEYWELL INTERNATIONAL INC., Morris Plains, NJ (US)

(72) Inventors: SOUMENDRA MOHAN BANERJEE, NEW DELHI (IN); KISHEN MANJUNATH, BANGALORE (IN)

(21) Appl. No.: 15/952,654

(22) Filed: Apr. 13, 2018

(51) Int. Cl. G05B 13/04; G05B 13/02

(52) U.S. Cl. CPC G05B 13/048; G05B 13/0285

(57) ABSTRACT

A method of increasing reliability for a reactor effluent air cooler (REAC). The method includes providing a process facility computer communicatively coupled to at least one REAC including an air condenser with a plurality of field devices coupled thereto. The process facility computer includes a processor connected to a memory device storing a REAC predictive maintenance model. The REAC predictive maintenance model implements retrieving history data including at least one historical REAC value from the memory and receiving real-time data from the field devices including at least one real-time REAC value. A digital twin calculates a current reliability value for the REAC using the historical REAC data and the real-time REAC value. The method further includes comparing the current reliability value to a predetermined reliability value and generating an alert indicating that the REAC needs current maintenance whenever the current reliability value is less than the predetermined reliability value.

### FIELD

Disclosed embodiments relate predicting heat exchanger reliability and maintenance in an industrial process facility, more particular to prediction reactor effluent air cooler reliability and maintenance.

### BACKGROUND

Process facilities are used in various industries such as petroleum or chemical refining, pharmaceutical, ore refining pulp and paper, or other manufacturing operations. Processing facilities are often managed using process control systems. Processing facilities can include manufacturing plants, chemical plants, crude oil refineries, ore processing plants, and paper or pulp manufacturing plants. These industries typically use continuous processes and fluid processing. Process control systems typically manage the use of motors, valves, sensors, gauges and other industrial equipment in the processing facilities.

Process facilities use process control systems including various field devices to measure and sense process parameters. The field devices can include tank level gauges, temperature sensors, pressure sensors, chemical concentration sensors, valve controllers, actuators and other devices. A process facility can use tens or hundreds of field devices to monitor and control the process(es).

Process facilities often include heat exchangers, with a particular type of heat exchanger being a reactor effluent air cooler (REAC). In a hydrocarbon processing facility, a REAC is used in the high-pressure recycle gas loop. The REAC provides the final cooling before the vapor (recycle gas) is separated from the oil effluent and the sour water. The outlet temperature impacts recycle gas molecular weight as larger hydrocarbon molecules ‘drop out’ of the vapor phase. The same mechanism also affects the hydrogen partial pressure, which impacts reactor catalyst life.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize a reactor effluent air cooler (REAC) generally includes an air condenser having metal tubes or pipes that during operation contain high pressure hydrocarbons and a surrounding container that directs cooling air over the tubes. Operating under high pressures and temperatures, the REAC experiences harsh operating conditions. Moreover, as the crude oil incoming feedstock in hydrocarbon processing has increased in sulfur and nitrogen content, the concentrations of ammonium bisulphide (NH₄HS) in the REAC have also increased. One specific problem that can occur in a REAC is metal corrosion due to NH₄HS and ammonium chloride (NH₄Cl) precipitation, which can lead to a pressure drop build-up and/or erosion-corrosion. Another specific problem that can occur in a REAC is weld failure due to NH₄HS induced stress cracking. If the REAC fails, the whole process facility may need to shut down in order to perform repairs.

Disclosed embodiments solve the problem of REAC failures by including a method of increasing reliability for REAC. The method includes providing a process facility computer communicatively coupled to at least one REAC including an air condenser with a plurality of field devices coupled thereto in an industrial facility configured to run an industrial process. The process facility computer includes a processor connected to a memory device storing a REAC predictive maintenance model that comprises a digital twin of the REAC and an artificial intelligence (AI) platform. The REAC predictive maintenance model implements retrieving history data including at least one historical REAC value from the memory and receiving real-time data from the plurality of field devices including at least one real-time REAC value. The digital twin calculates a current reliability value for the REAC using the historical REAC data including the historical REAC value and the real-time REAC value. The method further includes comparing the current reliability value to a predetermined reliability value and generating an alert indicating that the REAC needs current maintenance whenever the current reliability value is less than the predetermined reliability value.

### BRIEF DESCRIPTION OF THE DRAWINGS

FIG. 1 is a block diagram of an example system for predicting REAC reliability and maintenance in an industrial process facility, according to an example embodiment.

FIG. 2 is a block diagram of an example process facility computer, according to an example embodiment.

FIG. 3 is a diagrammatic view of an example REAC, according to an example embodiment.

FIG. 4 is an example table of real time REAC values, according to an example embodiment.

FIG. 5 is an example table of historical REAC values, according to an example embodiment.

FIG. 6 is a flow chart that shows steps in an example method of predicting REAC reliability and maintenance, according to an example embodiment.

FIG. 6 is a flow chart that shows steps in an example method of predicting REAC reliability and maintenance, according to an example embodiment.

FIG. 7 is a flow chart that shows steps in an example method of generating an adaptive REAC model, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

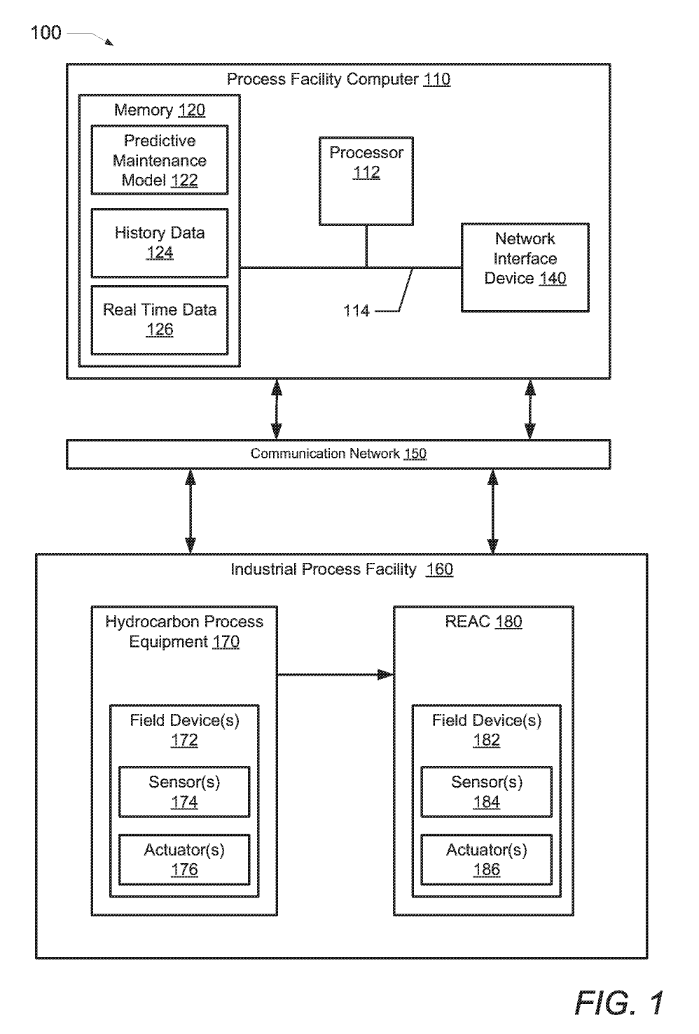

FIG. 1 illustrates a block diagram of an example system 100 for predicting REAC reliability and maintenance. As shown in FIG. 1, system 100 comprises a process facility computer 110 that is in communication with one or more field devices 172 and 182 located in an industrial process facility (IPF) 160 via a communication network 150.

IPF 160 can be a variety of manufacturing plants or storage locations that handle, process, store and transport a powder, liquid or fluid material. IPF 160 can include manufacturing plants, chemical plants, crude oil refineries, ore processing plants, and paper manufacturing plants. These industries and facilities typically use continuous processes and fluid processing.

IPF 160 can include hydrocarbon process equipment 170 and REACs 180. Hydrocarbon process equipment 170 can include a variety of process equipment such as coking units, distillation columns, hydrocrackers and vacuum distillation units.

Hydrocarbon process equipment 170 comprises field devices 172 that include sensors 174 and actuators 176. Field devices 172, sensors 174 and actuators 176 are mounted to or are in communication with industrial equipment such as industrial control devices or function as measurement devices within the hydrocarbon process equipment 170. Field devices 172 sense, control and record parameters and movement of materials within hydrocarbon process equipment 170. For example, field devices 172 can include pump motor controls and recording devices. Sensors 174 can measure process parameters within hydrocarbon process equipment 170 such as temperature, pressure, volume and chemical concentrations. Actuators 176 can control the operation of valves and switches to regulate the flow of fluids or gases.

The output of the hydrocarbon process equipment 170 is coupled to REAC 180. REAC 180 comprises field devices 182 that include sensors 184 and actuators 186. Field devices 182, sensors 184 and actuators 186 are mounted to or are in communication with industrial equipment such as industrial control devices or function as measurement devices within REAC 180. Field devices 182 sense, control and record parameters and movement of materials within REAC 180. For example, field devices 182 can include fan motor controls and recording devices. Sensors 184 can measure process parameters within REAC 180 such as temperature, pressure, volume and chemical concentrations. Actuators 176 can control the operation of valves and switches to regulate the flow of fluids or gases within REAC 180.

Process facility computer 110 includes a processor 112 (e.g., digital signal processor (DSP), microprocessor or microcontroller unit (MCU)) having an associated memory device or memory 120 that stores a predictive maintenance model 122. Processor 112 can perform any one or more of the operations, applications, methods or methodologies described herein. A processor 112 is needed to perform the data processing needed to implement disclosed embodiments because a human cannot monitor, record and perform calculations from real time process data provided essentially continuously being updated on the order of milliseconds as this is clearly too fast for a person to do. Processor 112 is also coupled to a network interface device 140 which facilitates communication with a communication network 150. Processor 112 is coupled to memory 120 and network interface device 140 via a system bus 114.

Memory 120 stores history data 124 and real time data 126. Real time data 126 are process parameters or values 124 that are received in a generally continuous manner from field devices 182, sensors 184 and actuators 186 via communication network 150 from REAC 180. History data 124 can include data about the design, construction materials and testing of REAC 180. In one embodiment, history data 124 can also include real time data 126 received over a period of time and then stored to memory 120 as history data. History data 124 also includes a time associated with the collection of the process parameters or values by the respective field device 182, sensor 184 or actuator 186.

Processor 112 implements the predictive maintenance model 122 which determines when a REAC requires maintenance based on REAC models using real time data and history data. Processor 112 retrieves at least one REAC model from memory 120. Processor 112 retrieves history data 124 from memory 120. History data 124 includes at least one historical REAC value. Processor 112 receives real time data 126 from field devices 182. The real time data 126 includes at least one real time REAC value. Processor 112 calculates a reliability of REAC 180 using at least one process model, the history heat data and the real time data. Processor 112 determines if REAC 180 needs maintenance based on the calculated reliability. In response to REAC 180 needing maintenance, processor 112 automatically generates an alert that the REAC needs maintenance.

By adding intelligence to the process facility computer only REACs that actually require maintenance are scheduled for maintenance. Predicting REAC reliability and maintenance based on real time data and history data as disclosed instead of a conventional fixed scheduled maintenance every several month(s) even though the REAC may not have any defects or issues is recognized to avoid wasting time and money on unnecessary repairs. In addition, predicting REAC reliability and maintenance based on real-time data and history data as disclosed allows carrying out maintenance activities before a potential failure of the REAC occurs.

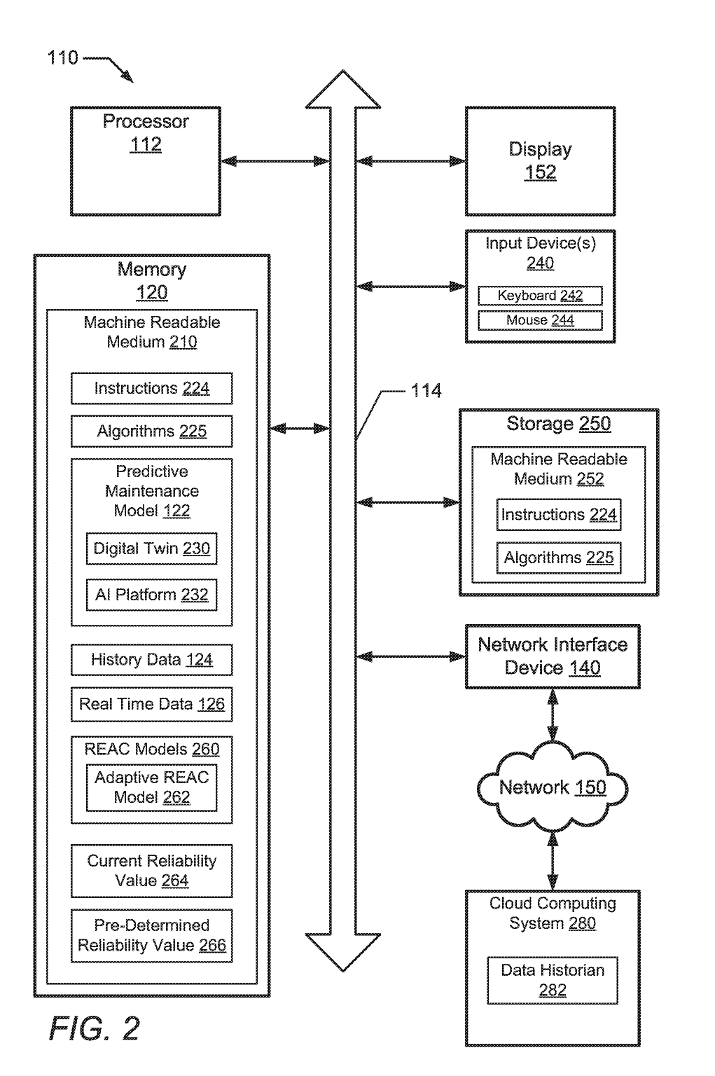

FIG. 2 illustrates an example block diagram of process facility computer 110 within which a set of instructions 224 and/or algorithms 225 can be executed causing the process facility computer 110 to perform any one or more of the methods, processes, operations, applications, or methodologies described herein.

Process facility computer 110 includes one or more processors 112 such as a central processing unit (CPU) and a storage device such as memory 120, which communicate with each other via system bus 114 which can represent a data bus and an address bus. Memory 120 includes a machine readable storage medium 210 on which is stored one or more sets of software such as instructions 224 and/or algorithms 225 embodying any one or more of the methodologies or functions described herein. Memory 120 can store instructions 224 and/or algorithms 225 for execution by processor 112. The process facility computer 110 further includes a display 152 such as a video screen that is connected to system bus 114. The process facility computer 110 also has input devices 240 such as an alphanumeric input device (e.g., keyboard 242) and a cursor control device (e.g., a mouse 244) that are connected to system bus 114.

A storage device 250, such as a hard drive or solid state drive, is connected to and in communication with the system bus 114. The storage device 250 includes a machine readable medium 252 on which is stored one or more sets of software such as instructions 224 and/or algorithms 225 embodying any one or more of the methodologies or functions described herein. The instructions 224 and/or algorithms 225 can also reside, completely or at least partially, within the memory 120 and/or within the processor 112 during execution thereof. The memory 120 and the processor 112 also contain machine readable media.

While the machine readable storage medium 210 is shown in an example embodiment to be a single medium, the term “machine readable medium” should be taken to include a single medium or multiple media (e.g., a centralized or distributed database, and/or associated caches and servers) that store the one or more sets of instructions. The term “machine readable medium” shall also be taken to include any medium that is capable of storing, encoding or carrying a set of instructions for execution by the computer system and that cause the computer system to perform any one or more of the methodologies shown in the various embodiments of this Disclosure. The term “machine readable medium” shall accordingly be taken to include, but not be limited to, solid-state memories, optical and magnetic media, and carrier wave signals.

Process facility computer 110 further includes a network interface device 140 that is connected to system bus 114. Network interface device 140 is coupled to communication network 150. Communication network 150 can be a wide variety of communication systems such as hardwired networks including the internet or wireless networks including Wi-Fi or local area networks. A cloud computing system 280 is also in communication with the network 150. Cloud computing system 280 includes a data historian 282 that can also store history data about REAC 180.

Machine readable medium 210 further stores predictive maintenance model 122. The predictive maintenance model 122 when executed by processor 112 can determine at a future point in time when REAC 180 requires maintenance before a potential failure can occur. Predictive maintenance model 122 comprises a digital twin 230 and an artificial intelligence (AI) platform 232.

Digital twin 230 is a digital replica of physical assets, processes and systems such as REAC 180 that can be used for various purposes. The digital representation provides both the elements and the dynamics of how a device operates throughout its life cycle. Digital twins integrate artificial intelligence, machine learning and software analytics with data to create living digital simulation models that update and change as their physical counterparts change. A digital twin continuously learns and updates itself from multiple sources to represent its near real-time status, working condition or position. A digital twin also integrates historical data from past machine usage to factor into its digital model. AI platform 232 uses algorithms and software to approximate human cognition in the analysis of predicting maintenance of REAC 180.

Machine readable storage medium 210 also stores history data 124 and real time data 126. Real time data 126 are process parameters or values 124 that are received in a generally continuous manner from field devices 182, sensors 184 and actuators 186 via communication network 150 from the REAC 180. History data 124 can include data about the design, construction materials and testing of REAC 180. In one embodiment, history data 124 can also include real time data 126 received over a period of time and then stored to memory 120 as history data. History data 124 also includes a time associated with the collection of the process parameters or values by the respective field device 182, sensor 184 or actuator 186. In one embodiment, process facility computer 110 receives real time data 126 over a period of time and then stores the received parameters and values for the real time data to history data 124.

Machine readable storage medium 210 further stores REAC models 260. REAC models 260 are models that simulate the reliability of REAC 180 over time. REAC models 260 can include multiple models to contain enough data over time to predict reliability. Given a set of REAC models, the models will have enough data over time to predict reliability. An IPF can have enough data based on years of operation of the unit to predict reliability. One of the REAC models 260 can include a model that mines the existing REAC real time and history data to tune (self-modify) the model to a state where reliability predictions are more accurate. REAC models 260 can further include models based on the design or geometry of REAC 180 including simulated flows of both liquids through tubes and air through housings.

REAC models 260 are high fidelity models that are developed using a simulation engine for an instance of plant asset/unit. It is a digital representation of physical plant asset/unit with associated fault models.

Other REAC models can combine history data 124 and real time data 126 to forecast fault conditions (fault modes) and provide accurate reliability predictions for future dates of maintenance activities. The reliability predictions can include not only future dates of maintenance activities, but also which activities are required to be performed on the future dates. Over time a repository or database of the fault modes can be generated that can be the basis of an adaptive REAC model 262.

The adaptive REAC model 262 can use Bayesian inference or long short term memory (LSTM) techniques on the database of fault modes. Bayesian inference is a method of statistical inference in which Bayes' theorem is used to update the probability for a hypothesis as more evidence or information (fault mode database) becomes available. A recurrent neural network (RNN) is a network of nodes, each with a directed connection to every other node. An RNN comprises a plurality of LSTM units often together called an LSTM network. A common LSTM unit is composed of a cell, an input gate, an output gate and a forget gate. The cell is responsible for “remembering” values over arbitrary time intervals. The expression long short-term refers to the fact that LSTM is a model for the short-term memory which can last for a long period of time. LSTM is well-suited to classify, process and predict time series given time lags of unknown size and duration between events such as fault modes.

Processor 112 can generate adaptive REAC models 262 that mine the existing REAC data (i.e., history data 124 and real time data 126) to modify the adaptive REAC model where reliability predictions are more accurate. The historical data, combined with real-time data can be used to continuously tune the models for accurate predictions.

In one embodiment, the REAC models and real time data can be used to identify anomalies in the operation of REAC 180 and generate fault modes. A database or repository of fault modes can be generated. The repository of fault modes and domain knowledge can be used to generate adaptive REAC model 262. The adaptive REAC model 262 can use Bayesian inference and long short term memory (LSTM) techniques on the database of fault modes. In one embodiment, the adaptive REAC model can use real time data to detect fault modes. After enough fault modes have been determined, the fault mode data can be used to build an adaptive REAC model that uses real time data to eliminate the need for the upfront generation of other REAC models.

Adaptive REAC model 262 is a probabilistic graphical model (adaptive, data driven model) that represents the set of REAC variables and their dependencies. The adaptive REAC model 262 is trained based on predicted faults received from a high-fidelity digital twin 230. Errors in the output from digital twin 230 are used to tune the adaptive REAC model 262 over time to predict faults in the REAC 180.

Machine readable storage medium 210 further stores current reliability value 264 and pre-determined reliability value 266. Digital twin 230 can calculate current reliability value 264 and compare it to pre-determined reliability value 266 in order to determine if maintenance of REAC 180 is required. Pre-determined reliability value 266 can be determined by a user based on experience operating IPF 160.

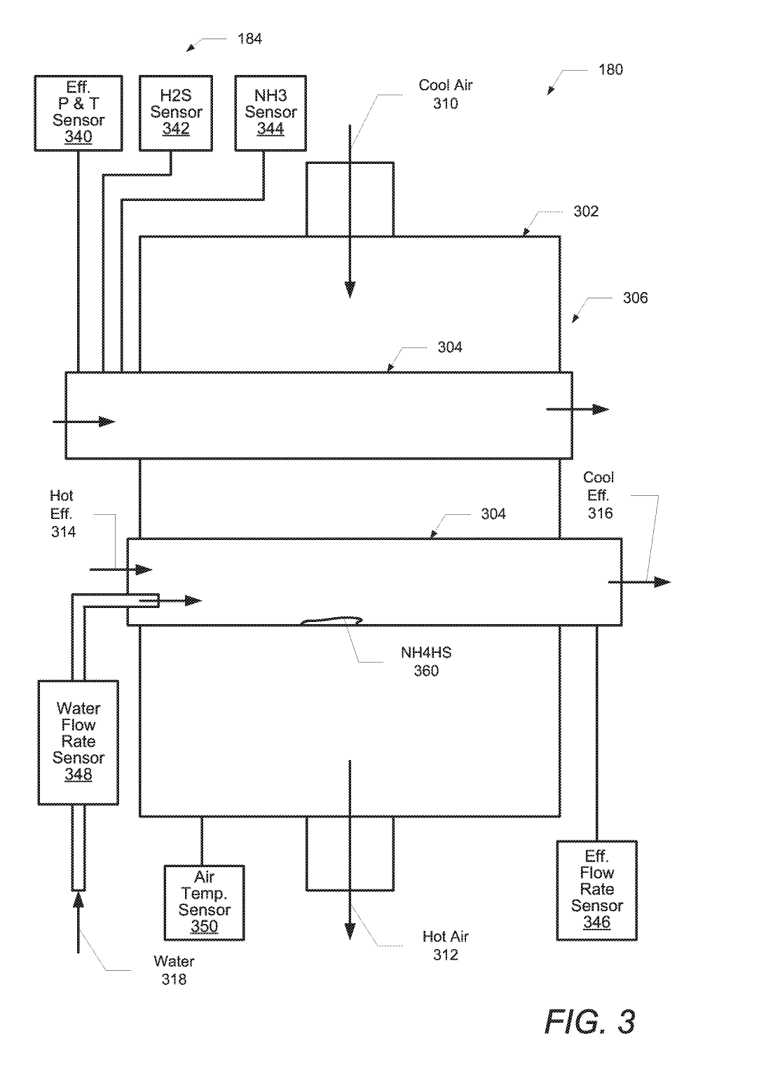

FIG. 3 illustrates a diagrammatic view of a heat exchanger or REAC 180 (herein referred to as REAC 180). REAC 180 includes a container or housing 302. Cool air 310 can be blown into and through housing 302 via one or more fans (not shown). Hot air 312 exits housing 302. Several REAC tubes or pipes 304 (herein called tubes) extend through housing 302. While several tubes 304 are shown, REAC 180 can contain hundreds or thousands of tubes 304. Housing 302 and tubes 304 form an air condenser 306. Various hydrocarbon effluents under pressure flow through tubes 304 and are cooled by the air flowing through housing 302. Hot effluent 314 from a hydrocarbon reactor enters the tubes 304 and cool effluent 316 exiting tubes 304 is directed to a separate vessel. One problem that can occur inside tubes 304 is metal corrosion due to ammonium bisulphide 360 precipitation on the inside of tubes 304. In order to reduce the ammonium bisulphide 360 precipitation on the inside of tubes 304, water 318 can be injected with the incoming hot effluent 314 into tubes 304.

Tubes 304 can be formed from a variety of materials that have differing corrosion resistance to ammonium bisulphide and ammonium chloride in the effluent flow. Some materials used in tubes 304 include carbon steel, type 400 series stainless steels, type 300 series stainless steels, duplex stainless steel alloys 3RE60 and 2205, alloy 800, alloy 825 and alloy 625. Plain carbon steel has the lowest resistance to corrosion from ammonium bisulphide and can be used with ammonium bisulphide concentrations up to 3.0 weight percent. Duplex steel 2205 has an intermediate resistance to corrosion from ammonium bisulphide and can be used with ammonium bisulphide concentrations up to 6.0 weight percent. Stainless steel 825 has the highest resistance to corrosion from ammonium bisulphide and can be used with ammonium bisulphide concentrations up to 15.0 weight percent.

Several sensors 184 can be mounted to and with REAC 180 to sense and measure various REAC operating parameters and values. Sensors 184 can include an effluent pressure and temperature sensor 340, hydrogen sulfide (H₂S) concentration sensor 342, ammonia (NH₃) concentration sensor 344, effluent flow rate sensor 346, water flow rate sensor 348 and air temperature sensor 350.

Effluent pressure and temperature sensor 340 can measure the pressure and temperature of the effluent in REAC 180 and transmit real time pressure and temperature values to process facility computer 110. H2S concentration sensor 342 can measure the concentration of hydrogen sulfide in the effluent in REAC 180 and transmit real time concentration values to process facility computer 110. NH₃ concentration sensor 344 can measure the concentration of ammonia in the effluent in REAC 180 and transmit real time concentration values to process facility computer 110.

Effluent flow rate sensor 346 can measure the flow rate of the effluent in REAC 180 and transmit real time flow rate values to process facility computer 110. Water flow rate sensor 348 can measure the flow rate of water being injected into REAC 180 and transmit real time flow rate values to process facility computer 110. Air temperature sensor 350 can measure the temperature of the air in REAC 180 and transmit real time temperature values to process facility computer 110. In one embodiment, REAC 180 has an associated isometric layout and mechanical dimensions. Digital twin 230 (FIG. 2) can be created or generated using the historical REAC values in history data 124, the isometric layout, and air condenser 306 mechanical design of REAC 180.

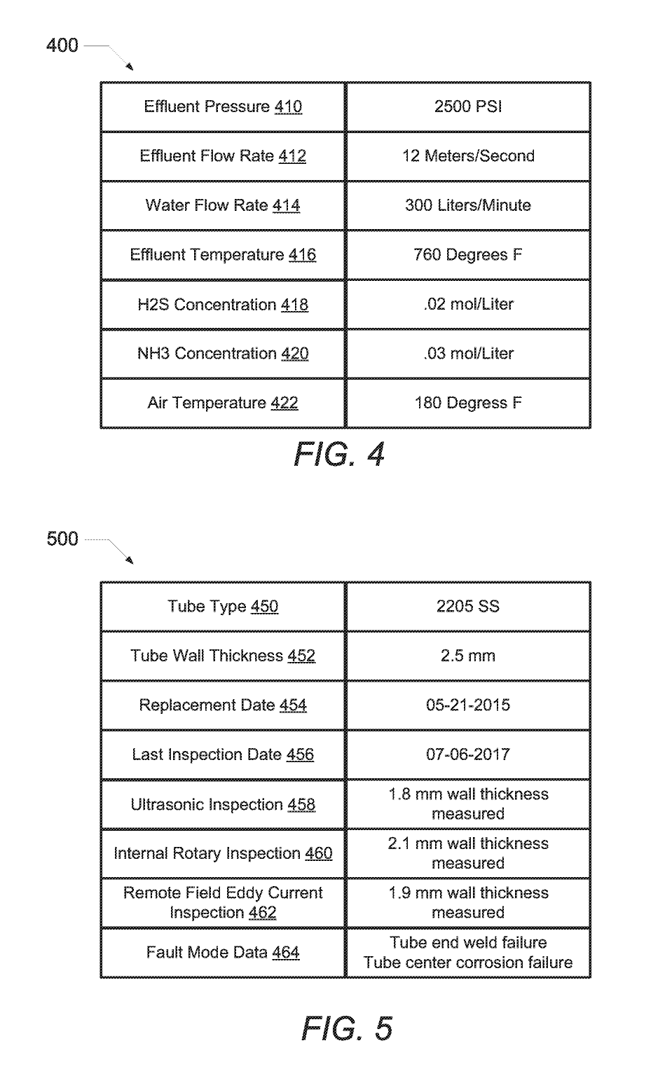

FIG. 4 is a table 400 of real time sensed and measured REAC parameters and values. In one embodiment, the values of table 400 are sensed and measured by sensors 184 of FIG. 3 and transmitted to process facility computer 110 where they are stored to real time data 126. Table 400 includes effluent pressure 410, effluent flow rate 412, water flow rate 414, effluent temperature 416, hydrogen sulfide concentration 418, ammonia concentration 420 and air flow rate 422. For example, the water flow rate 412 has a real time value of 300 liters/minute. The parameters and values of table 400 can be used as inputs to REAC models 260.

FIG. 5 is a table 500 of historical REAC parameters and values. In one embodiment, one or more of the parameters and values of table 500 are initially stored during a start-up operation to history data 124 in memory 120 of FIG. 1. At a later time, one or more of the parameters and values of history data 124 can be modified and/or added by processor 112. Table 500 includes tube type 450, tube wall thickness 452, tube replacement date 454, last inspection date 456, ultrasonic inspection 458, internal rotary inspection 460, remote field eddy current inspection 462 and fault mode data 464. For example, the tube wall thickness 452 has a history value of 2.5 millimeters. The parameters and values of table 500 can be used as inputs to REAC models 260.

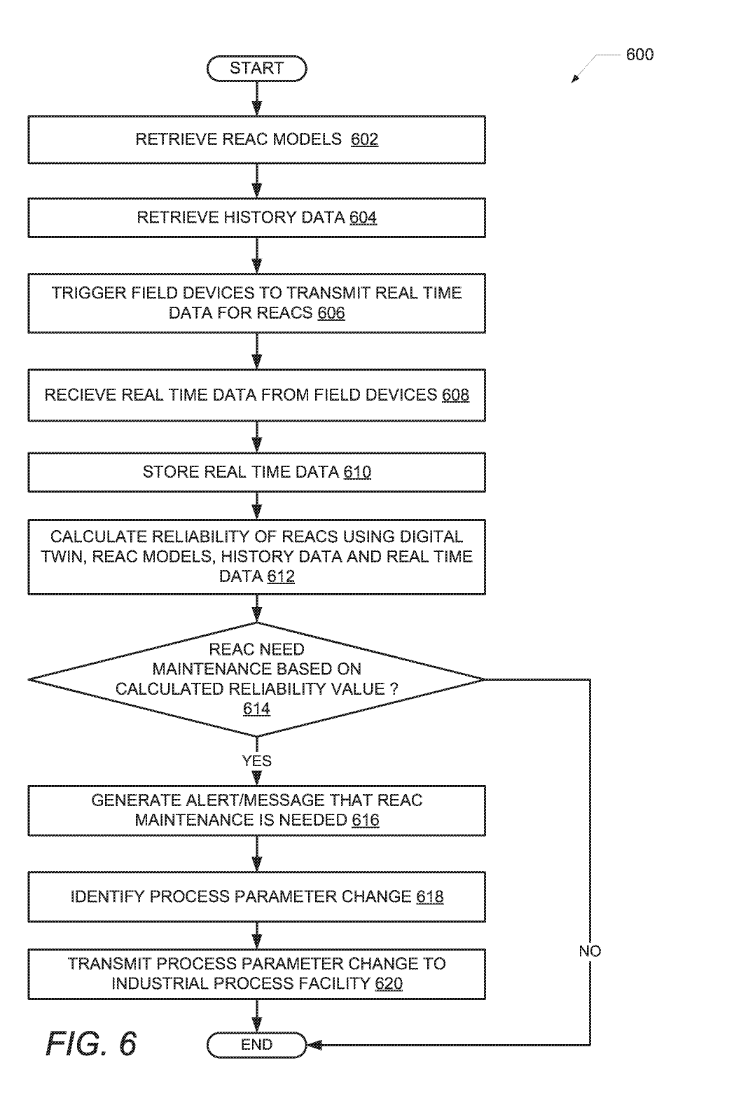

FIG. 6 is a flow chart showing steps in an example method 600 for predicting reliability and maintenance of REAC 180. With additional reference to FIGS. 1-5, method 600 can be implemented via the execution of instructions 224 and/or algorithms 225 by processor 112 within process facility computer 110 and specifically by the execution of predictive maintenance model 122 by processor 112.

Method 600 begins at the start block and proceeds to block 602. At block 602, processor 112 retrieves REAC models 260 from memory 120. Processor 112 retrieves history data 124 from memory 120 (block 604). Processor 112 triggers field devices 182 to transmit real time data 126 about REAC 180 to process facility computer 110 (block 606). Processor 112 receives the real time data from field devices 182 (block 608) and stores the real time data 126 to memory 120 (block 610).

At block 612, processor 112 calculates a current reliability value 264 of REAC 180 using digital twin 230, REAC models 260, history data 124 and real time data 126. In one embodiment, the reliability can be a predicted future date of failure of REAC 180. In another embodiment, the reliability can be a predicted number of days until maintenance is required. Processor 112 compares current reliability value 264 to predetermined reliability value 266 and determines if maintenance of REAC 180 is needed based on if the current reliability value 264 is less than the predetermined reliability value 266 (decision block 614). In response to determining that maintenance of REAC 180 is not needed, method 600 ends. In response to determining that maintenance of REAC 180 is needed, processor 112 generates an alert/message that maintenance of REAC 180 is needed (block 616). In one embodiment, processor 112 can generate an alert/message on display 152. In another embodiment, processor 112 can send an alert/message to an operator of IPF 160. Processor 112 identifies one or more process parameter changes for IPF 160 (block 618) to increase the reliability of REAC 180, and transmits the process parameter changes to IPF 160 (block 620). For example, one process parameter change can be implemented by the processor 112 sending a control signal that directs the actuator 186 to move a valve coupled to the REAC 180 to reduce pressure within the REAC 180. Method 600 then ends.

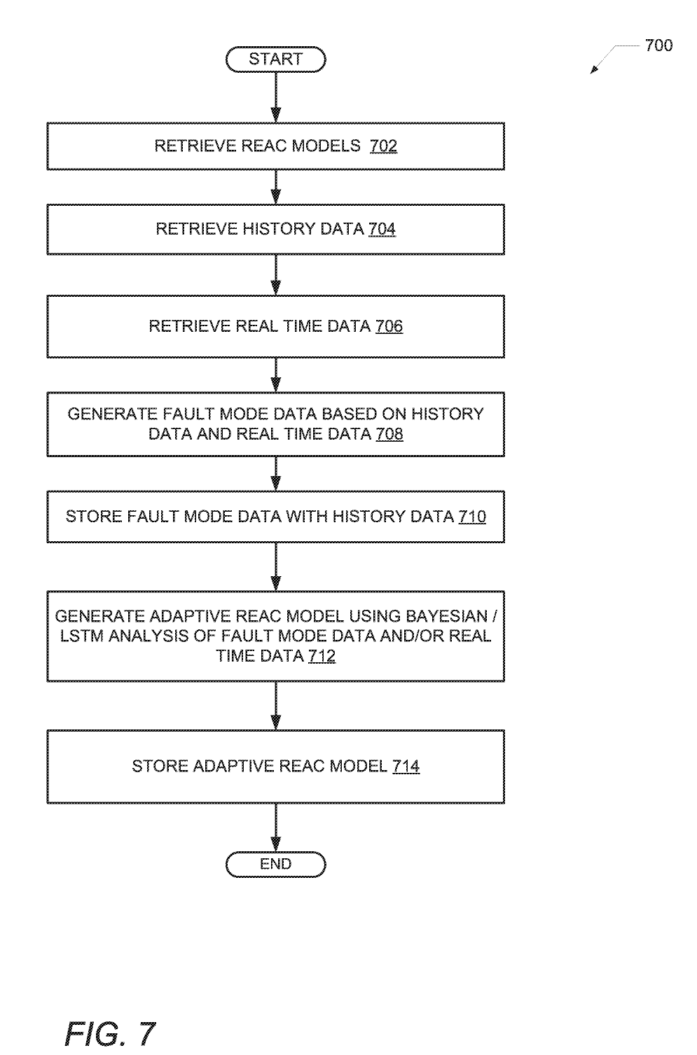

FIG. 7 is a flow chart showing steps in an example method 700 for generating an adaptive REAC model 262. With additional reference to FIGS. 1-5, method 700 can be implemented via the execution of instructions 224 and/or algorithms 225 by processor 112 within process facility computer 110 and specifically by the execution of predictive maintenance model 122 by processor 112.

Method 700 begins at the start block and proceeds to block 702. At block 702, processor 112 retrieves REAC models 260 from memory 120. Processor 112 retrieves history data 124 from memory 120 (block 704) and real time data 126 from memory 120 (block 706). Processor 112 generates fault mode data 464 based on history data 124 and real time data 126 (block 708) and stores the fault mode data 464 with history data 124 to memory 120 (block 710).

At block 712, processor 112 generates adaptive REAC model 262 using REAC models 260 and fault mode data 464. In one embodiment, REAC model 262 is generated using Bayesian inference and long short term memory (LSTM) techniques on fault mode data 464. Processor 112 stores adaptive REAC model 262 to memory 120 (block 714). Method 700 then ends.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

1. A method of increasing reliability for a reactor effluent air cooler (REAC), comprising:
providing a process facility computer communicatively coupled to at least one REAC including an air condenser with a plurality of field devices coupled thereto in an industrial facility configured to run an industrial process, said process facility computer including a processor connected to a memory device storing a REAC predictive maintenance model comprising a digital twin of said REAC and a REAC adaptive model, said REAC predictive maintenance model implementing:
retrieving history data including at least one historical REAC value from at least one of said memory device and a cloud computing-based data historian;
receiving real time data from said plurality of field devices including at least one real-time REAC value,
said digital twin calculating a current reliability value for said REAC using said history data including said historical REAC value and said real time REAC value;
comparing said current reliability value to a predetermined reliability value, and
generating an alert indicating that said REAC needs current maintenance whenever said current reliability value is less than said predetermined reliability value.

2. The method of claim 1, wherein said digital twin is created using said historical REAC value, an isometric layout and air condenser design mechanical details of said REAC.

3. The method of claim 1, wherein said process facility computer further executes:
identifying at least one process parameter change to said industrial process to increase reliability of said REAC; and
transmitting a signal to implement said process parameter change.

4. The method of claim 1, wherein said real time data includes at least one of:
effluent pressure data;
effluent flow rate data;
water flow rate data;
effluent temperature data;
hydrogen sulfide concentration data;
ammonia concentration data; and
air temperature data.

5. The method of claim 1, wherein said history data includes at least one of:
tube type data;
replacement date data;
inspection date data;
ultrasonic inspection data;
internal rotary inspection data;
remote field eddy current inspection data; and
fault mode data.

6. The method of claim 1, wherein said process facility computer further executes:
retrieving a plurality of said REAC predictive maintenance models from said memory device, and
calculating a reliability of said REAC using said plurality of REAC predictive maintenance models.

7. The method of claim 1, wherein said REAC adaptive model includes bayesian inference and long short term memory (LSTM) techniques based on input from fault mode data.

8. A system of increasing reliability for a reactor effluent air cooler (REAC), comprising:
a process facility computer communicatively coupled to at least one REAC including an air condenser with a plurality of field devices coupled thereto in an industrial facility configured to run an industrial process, said process facility computer including a processor connected to a memory device storing a REAC predictive maintenance model comprising a digital twin of said REAC and a REAC adaptive model, wherein said process facility computer is programmed to implement said predictive maintenance model causing said process facility computer to:
retrieve history data including at least one historical REAC value from at least one of said memory device and a cloud computing-based data historian;
receive real time data from said plurality of field devices including at least one real-time REAC value, said digital twin calculating a current reliability value for said REAC using said history data including said historical REAC value and said real time REAC value;
compare said current reliability value to a predetermined reliability value; and
generate an alert indicating that said REAC needs current maintenance whenever said current reliability value is less than said predetermined reliability value.

9. The system of claim 8 wherein said digital twin is created using said historical REAC value, isometric layout and air condenser design mechanical details of said REAC.

10. The system of claim 8 wherein said predictive maintenance model further causes said process facility computer to:
identify at least one process parameter change to said industrial process to increase said reliability of said REAC; and
transmit a signal to implement said process parameter change.

11. The system of claim 8 wherein said real time data includes at least one of:
effluent pressure data;
effluent flow rate data;
water flow rate data;
effluent temperature data;
hydrogen sulfide concentration data;
ammonia concentration data; and
air temperature data.

12. The system of claim 8 wherein said history data includes at least one of:
tube type data;
replacement date data;
inspection date data;
ultrasonic inspection data;
internal rotary inspection data;
remote field eddy current inspection data; and
fault mode data.

13. The system of claim 8 wherein said predictive maintenance model further causes said process facility computer to:
retrieve a plurality of said REAC predictive maintenance models from said memory device, and
calculate a reliability of said REAC using said plurality of REAC predictive maintenance models.

14. The system of claim 8 wherein said REAC adaptive model includes bayesian inference and long short term memory (LSTM) techniques based on input from fault mode data.

15. A computer program product, comprising:
a tangible data storage medium that includes program instructions executable by a processor to enable said processor to execute a method of increasing reliability for a reactor effluent air cooler (REAC);
a process facility computer communicatively coupled to at least one REAC including an air condenser with a plurality of field devices coupled thereto in an industrial facility configured to run an industrial process, said process facility computer including said processor and said non-transitory data storage medium, said computer program product comprising:
code for retrieving history data including at least one historical REAC value from at least one of a memory device and a cloud computing based data historian;
code for receiving real time data from said plurality of field devices including at least one real-time REAC value, a digital twin calculating a current reliability value for said REAC using said history data including said historical REAC value and said real-time REAC value;
code for comparing said current reliability value to a predetermined reliability value; and
code for generating an alert indicating that said REAC needs current maintenance whenever said current reliability value is less than said predetermined reliability value.

16. The computer program product of claim 15, wherein said digital twin is created using said historical REAC value, isometric layout and air condenser design mechanical details of said REAC.

17. The computer program product of claim 15, wherein said computer program product further comprises:
code for identifying at least one process parameter change to said industrial process to increase reliability of said REAC; and
code for transmitting a signal to implement said process parameter change.

18. The computer program product of claim 15, wherein said real time data includes at least one of:
effluent pressure data;
effluent flow rate data;
water flow rate data;
effluent temperature data;
hydrogen sulfide concentration data;
ammonia concentration data; and
air temperature data.

19. The computer program product of claim 15, wherein said history data includes at least one of:
tube type data;
replacement date data;
inspection date data;
ultrasonic inspection data;
internal rotary inspection data;
remote field eddy current inspection data; and
fault mode data.

20. The computer program product of claim 15, wherein said computer program product further comprises:
code for retrieving a plurality of said REAC predictive maintenance models from said memory device, and
code for calculating a reliability of said REAC using said plurality of REAC predictive maintenance models.
